(19) United States
(12) Patent Application Publication
(10) Pub. No.: US 2023/0272643 A1
(43) Pub. Date: Aug. 31, 2023

(54) INTELLIGENT LOCK DEVICE WITH PHOTOELECTRIC SWITCH-CONTROLLED MOTOR

(71) Applicant: Guangdong Mansion Intelligent Technology Co.,Ltd, Zhongshan (CN)

(72) Inventors: Baoqiang Zhang, Zhongshan (CN); Weibo Kong, Zhongshan (CN)

(21) Appl. No.: 17/652,848

(22) Filed: Feb. 28, 2022

(51) Int. Cl. E05B 47/00; E05B 9/02; E05B 9/08; E05B 17/00

(52) U.S. Cl. CPC E05B 47/0012; E05B 9/02; E05B 9/084; E05B 17/0004; E05B 2047/0017; E05B 2047/002; E05B 2047/0067; E05B 15/10

(57) ABSTRACT

The present invention discloses an intelligent lock device with a photoelectric switch-controlled motor, which includes: a lock case and a rear mounting plate. An end face of the lock case is provided with a knob attraction plate, and a knob is mounted to the knob attraction plate. The rear mounting plate is attached to the lock case using a snap-fit connection. A transmission gear is installed at an inner side of the lock case, the transmission gear meshes with a motor module, and the motor module is fixed to a motor fixing plate. A gear bore is formed in a center of the transmission gear, a rotary rod penetrates through the gear bore, and the rotary rod is drive-connected to the knob. The rotary rod is connected to a connecting sleeve, the connecting sleeve penetrates through a circuit board to be connected to a deadbolt body, and the deadbolt body matches a plug follower. The intelligent lock device further includes: a door sensor bar and a door sensor plate. The door sensor bar is mounted to the door sensor plate, and a sensor magnet, is mounted at one side of the door sensor plate. The intelligent lock device is novel in structural design. With a door sensor function featuring, strong magnetic sensing, the intelligent lock device can realize automatic locking. Meanwhile, the knob can be detached from and attached to a rear lock body through a strong magnet.

### TECHNICAL FIELD

The present invention relates to the technical field of intelligent locks, in particular to an intelligent lock device with a photoelectric switch-controlled motor.

### BACKGROUND

There are many ways to control the locking and unlocking of American-standard locks, such as with a combination of a photoelectric switch and a Hall switch, or with a combination of a mechanical switch and a Hall switch. Currently available American-standard locks have a poor variety of structures and a low intelligence degree, thus needing to be improved.

### SUMMARY

An objective of the present invention is to provide an intelligent lock device with a photoelectric switch-controlled motor, so as to solve the above-mentioned problems in the background art.

In order to achieve the above objective, the present invention provides the following technical scheme of an intelligent lock device with a photoelectric switch-controlled motor including: a lock case and a rear mounting plate. A knob attraction plate is mounted to an end face of the lock case, and a knob is mounted to the knob attraction plate. The rear mounting plate is attached to the lock case using a snap-fit connection. A transmission gear is installed at an inner side of the lock case, the transmission gear meshes with a motor module, and the motor module is fixed to a motor fixing plate. A gear bore is foiined in a center of the transmission gear, a rotary rod penetrates through the gear bore, and the rotary rod is drive-connected to the knob. The rotary rod is connected to a connecting sleeve, the connecting sleeve penetrates through a circuit board to be connected to a deadbolt body, and the deadbolt body matches a plug follower. The intelligent lock device further includes: a door sensor bar and a door sensor plate. The door sensor bar is mounted to the door sensor plate, and a sensor magnet is mounted at one side of the door sensor plate.

Optionally, according to the intelligent lock device with a photoelectric switch-controlled motor provided by the present application, the circuit board is provided with a rotary rod hole, a photoelectric switch K3 for determining a gear state, and a photoelectric switch K2 and a photoelectric switch K1 for determining a rotation state of the rotary rod.

Optionally, according to the intelligent lock device with a photoelectric switch-controlled motor provided by the present application, an outer peripheral surface of the connecting sleeve is provided with a square shaft surface matching the rotary rod, and an inner cavity of the connecting sleeve is provided with a square hole matching the plug follower.

Optionally, according to the intelligent lock device with a photoelectric switch-controlled motor provided by the present application, the lock case is provided with a knob matching counterbore, an attraction plate mounting hole, a rotary rod mounting hole, a gear mounting base, an attraction plate positioning column limiting slot, a motor mounting detent, a motor plate fixing hole, a door sensor bar limiting slot, and a door sensor bar and plate fixing hole.

Optionally, according to the intelligent lock device with a photoelectric switch-controlled motor provided by the present application, a plurality of transmission teeth are evenly distributed on a periphery of the transmission gear, photoelectric baffles are arranged inside the gear bore of the transmission gear, and the transmission gear is further provided with a step bore matching the rotary rod.

Optionally, according to the intelligent lock device with a photoelectric switch-controlled motor provided by the present application, an outer wall of the rotary rod is provided with a photoelectric baffle, an upper end of the rotary rod is provided with an outer circle matching a lock case hole, an outer peripheral surface of the rotary rod is provided with a surface matching the transmission gear, an inner cavity of the rotary rod is provided with a square hole matching a joint pin, and the inner cavity of the rotary rod is further provided with a counterbore matching a protrusion of the attraction plate.

Optionally, according to the intelligent lock device with a photoelectric switch-controlled motor provided by the present application, the rear mounting plate is provided with a hole matching the connecting sleeve.

Optionally, according to the intelligent lock device with a photoelectric switch-controlled motor provided by the present application, the knob is composed of a knob base, a strong magnet and a knob case by hot melting and is detachable from the lock case, the knob base is provided with four projections A matching recesses of the knob attraction plate and is tightly attracted thereto. If the knob is changed by replacing the magnet with a hot-melt nut, the knob can be implemented as a fixed knob by assembling and hot-melting.

Optionally, according to the intelligent lock device with a photoelectric switch-controlled motor provided by the present application, the motor module is provided with an output gear and a motor module positioning boss, and the motor module fixing plate is provided with a motor positioning slot and at least one mounting screw through hole.

Optionally, according to the intelligent lock device with a photoelectric switch-controlled motor provided by the present application, the knob attraction plate is provided with a positioning pin, an iron washer, a mounting screw hole and a positioning boss, and the knob attraction plate is further provided with four recesses.

Compared with the related art, the present invention has the beneficial effects: the intelligent lock device is novel in structural design; with the door sensor function featuring, strong magnetic sensing, the intelligent lock device can realize automatic locking; meanwhile, the knob can be detached from and attached to a rear lock body through the strong magnet; and clue to the adoption of photoelectric control, the lock parts are simple in structure and easy to manufacture, and the processing and manufacturing of the circuit board are also easy and stable.

### BRIEF DESCRIPTION OF DRAWINGS

FIG. 1 is a structural diagram of the present invention;

FIG. 2 is a structural diagram of a knob of the present invention;

FIG. 3 is a structural diagram of a knob attraction plate of the present invention;

FIG. 4 is a side view of a lock case of the present invention;

FIG. 5 is a front view of a lock case of the present invention;

FIG. 6 is a structural diagram of the inside of a lock case of the present invention;

FIG. 7 is a structural diagram of a transmission gear of the present invention;

FIG. 8 is a structural diagram of a rotary rod of the present invention;

FIG. 9 is a structural diagram of a connecting sleeve of the present invention;

FIG. 10 is a structural diagram of a main control circuit board of the present invention;

FIG. 11 is a structural diagram of a rear mounting plate of the present invention;

FIG. 12 is a structural diagram of a motor module of the present invention;

FIG. 13 is a structural diagram of a motor module fixing plate of the present invention;

FIG. 14 is a structural diagram of a plug follower of the present invention;

FIG. 15 is a structural diagram of a door sensor bar of the present invention;

FIG. 16 is a structural diagram of a door sensor bar fixing plate of the present invention;

FIG. 17 is a structural diagram of a deadbolt body of the present invention;

FIG. 18 is a structural diagram of a sensor magnet of the present invention;

FIG. 19 is a structural diagram of a manual default state of the present invention; and

FIG. 20 is a structural diagram of a manual unlocking state of the present invention.

### DETAILED. DESCRIPTION

The technical schemes in the embodiments of the present invention are clearly and completely described in the following with reference to the drawings in the embodiments of the present invention. It is obvious that the described embodiments are only some of the embodiments of the present invention and are not all the embodiments. All other embodiments obtained by those of ordinary skill in the art based on the embodiments of the present invention without inventive effort are within the scope of the present invention.

In the description of the present invention, it should be noted that, orientation or positional relationships indicated by terms such as “up”, “down”, “inner”, “outer”, “front end”, “rear end”, “both ends” “one end”, “the other end” are based on the orientation or positional relationships shown in the accompanying drawings, and are to facilitate the description of the present invention and simplify the description only, rather than indicating or implying that the device or element referred to must have a specific orientation or be constructed and operated in a specific orientation, and therefore cannot be construed as limiting the present invention. In addition, the terms “first” and “second” are for the purpose of description only and should not be construed as indicating or implying relative importance.

It should be noted that, in the description of the present invention, the tell is “mount”, “provided with”, and “connect” should be interpreted in a broad sense unless explicitly defined and limited otherwise. For example, “connect” can mean a fixed connection, a detachable connection or an integral connection; can mean a mechanical connection or an electrical connection; and can mean a direct connection, an indirect connection by means of an intermediary, or internal communication between two elements. For those of ordinary skill in the art, the specific meaning of the terms mentioned above in the present invention should be construed to specific circumstances.

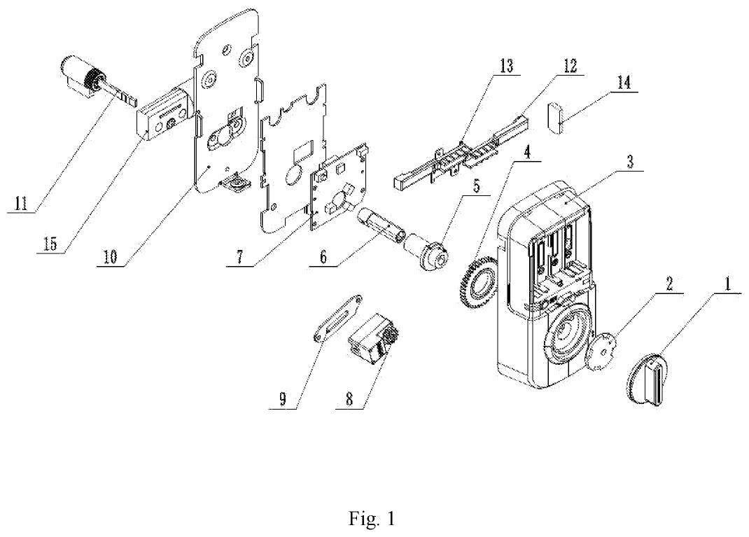

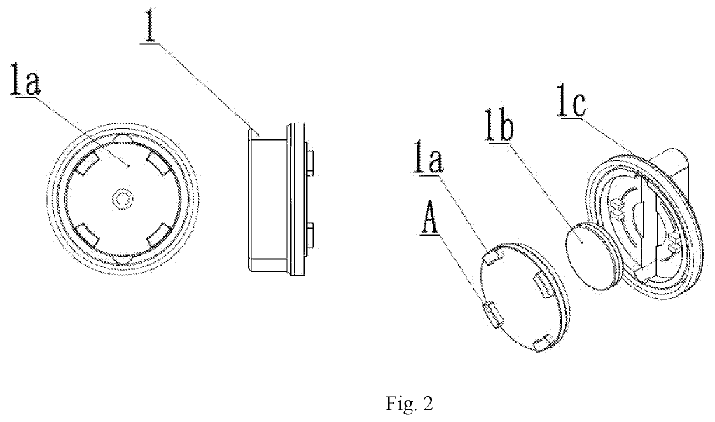

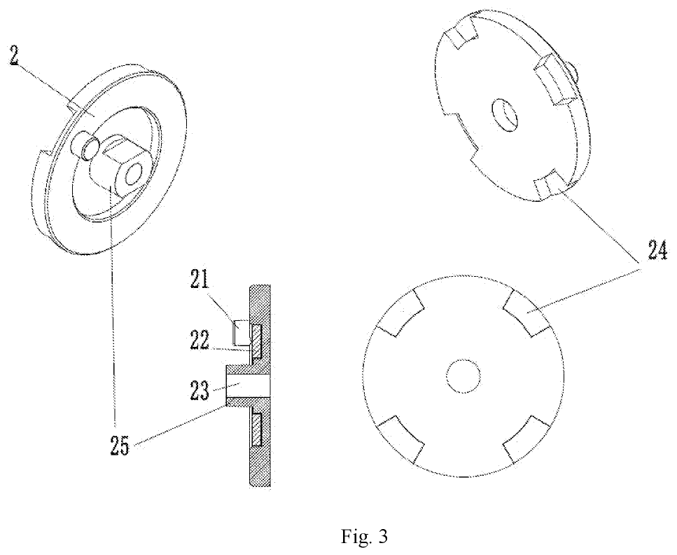

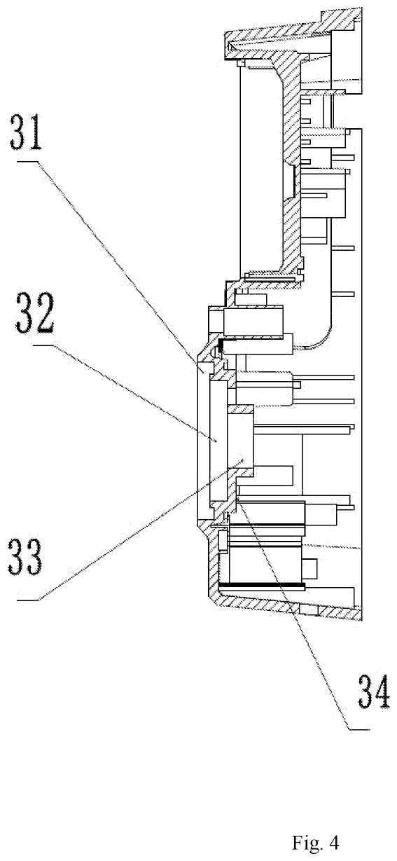

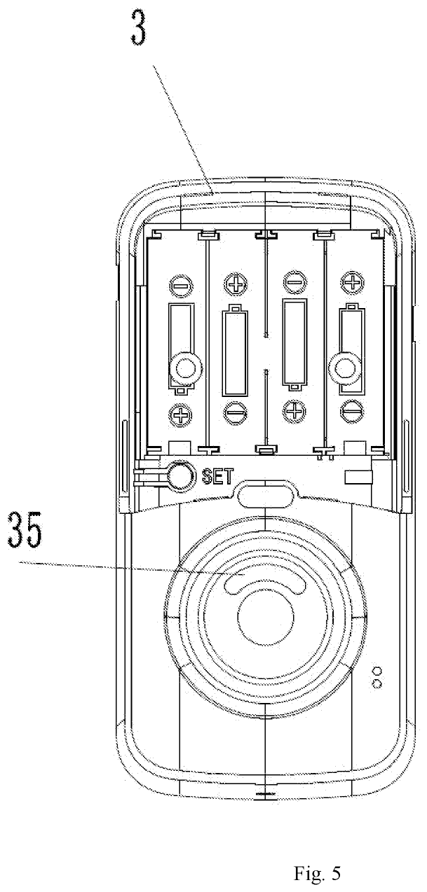

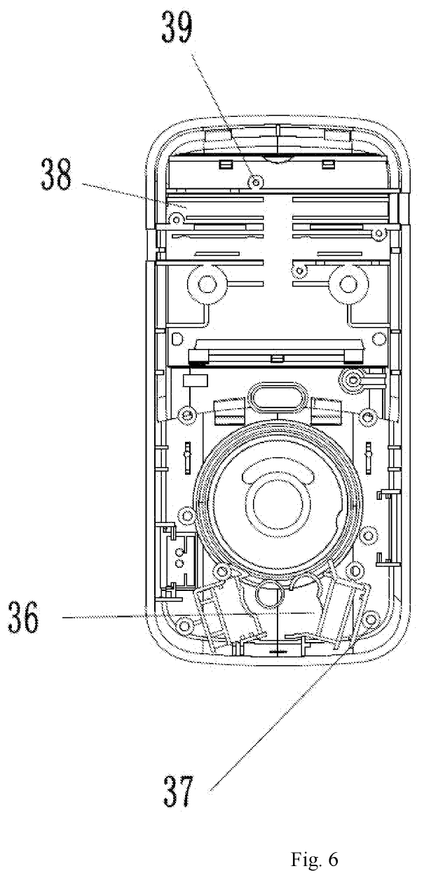

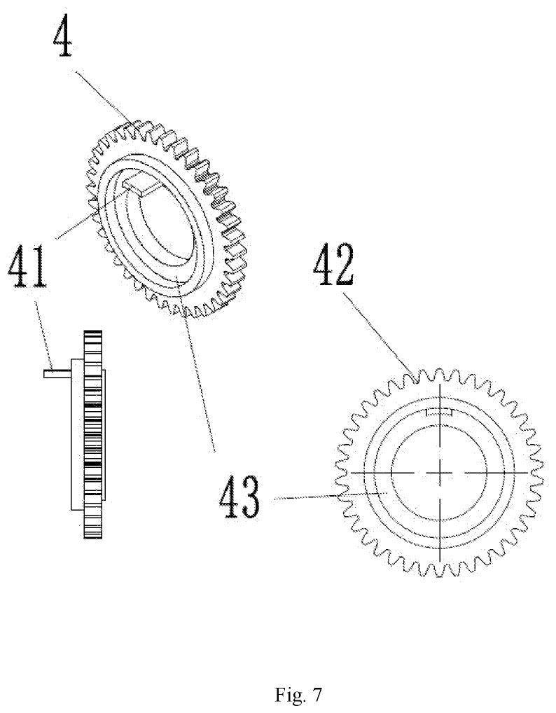

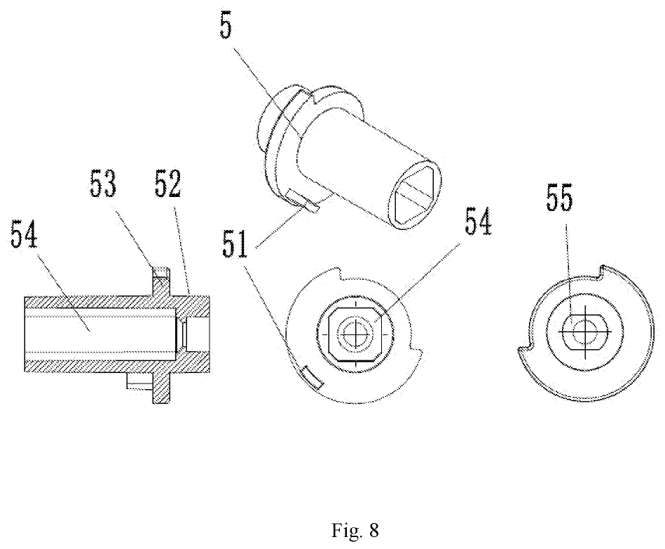

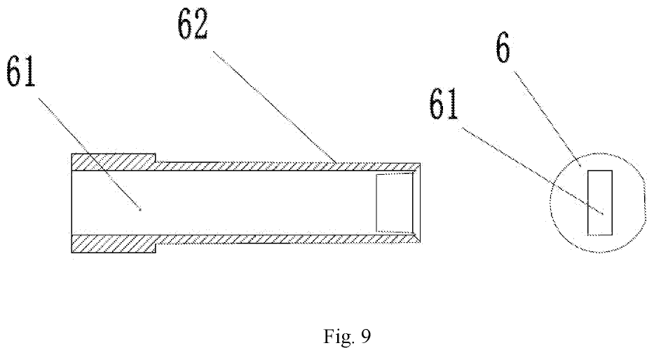

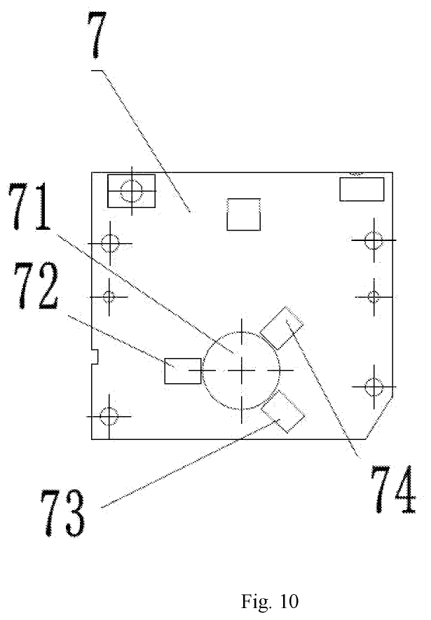

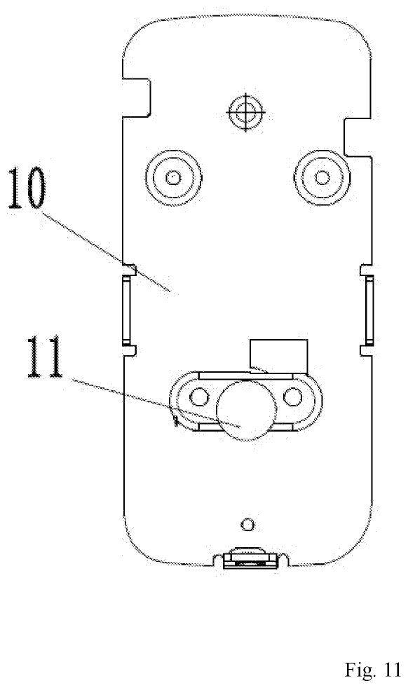

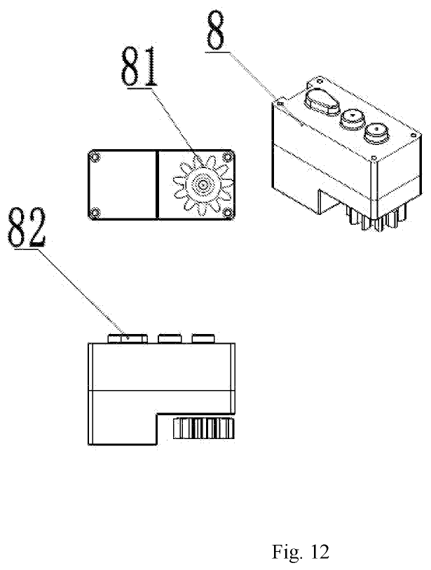

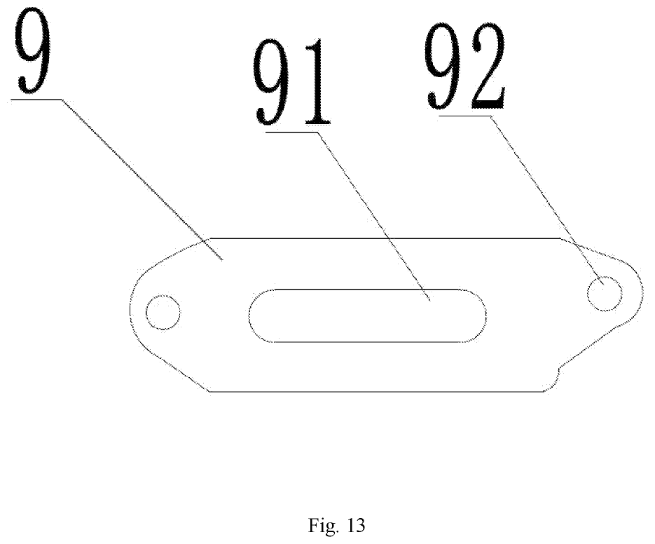

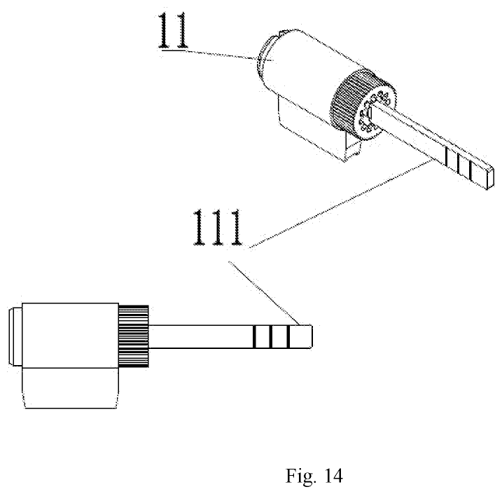

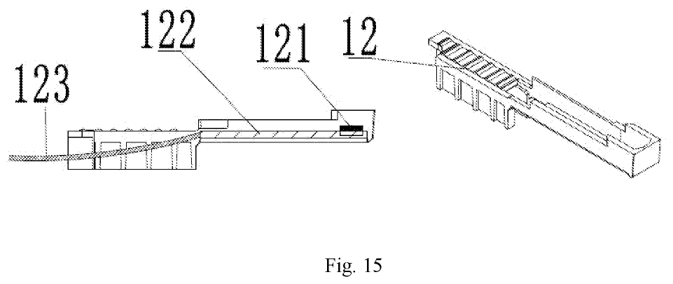

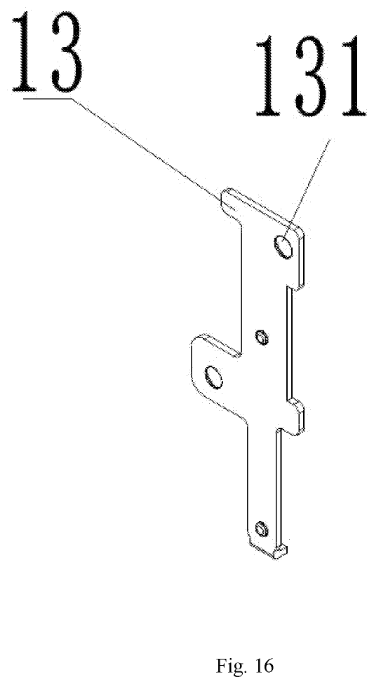

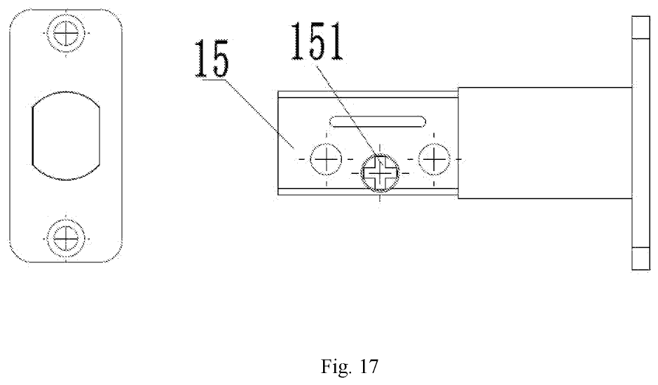

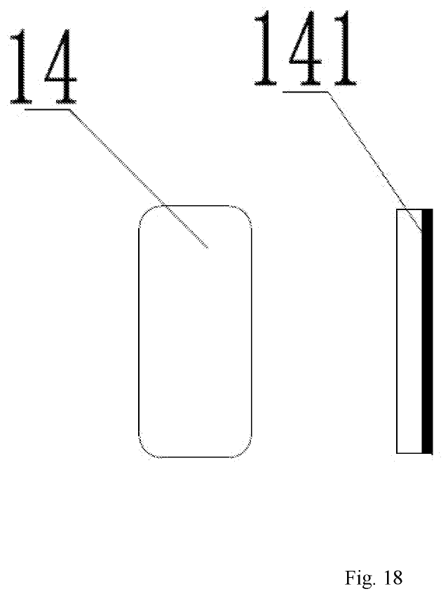

Referring to FIGS. 1-18, the present invention provides a technical scheme of an intelligent lock device with a photoelectric switch-controlled motor including: a lock case 3 and a rear mounting plate 10, a knob attraction plate 2 being mounted to an end face of the lock case 3, a knob 1 being mounted to the knob attraction plate 2, the rear mounting plate 10 being attached to the lock case 3 using a snap-fit connection, a transmission gear 4 being installed at an inner side of the lock case 3, the transmission gear 4 meshing with a motor module 8, the motor module 8 being fixed to a motor fixing plate 9, a gear bore being formed in a center of the transmission gear 4, a rotary rod 5 penetrating through the gear bore, the rotary rod 5 is drive-connected to the knob 1, the rotary rod 5 being connected to a connecting sleeve 6, the connecting sleeve 6 penetrating through a circuit board 7 to be connected to a deadbolt body 15, and the deadbolt body 15 matching a plug follower 11. The intelligent lock device further includes: a door sensor bar 12 and a door sensor plate 13, the door sensor bar 12 being mounted to the door sensor plate 13, and a sensor magnet 14 mounted at one side of the door sensor plate 13.

In the present invention, the knob is composed of a knob base, a strong magnet 2 and a knob case by hot melting and is detachable from the lock case, the knob base is provided with four projections A matching recesses of the knob attraction plate and is tightly attracted thereto. If the knob is changed by replacing the magnet with a hot-melt nut, the knob can be implemented as a fixed knob by assembling and hot-melting.

In the present invention, the knob attraction plate 2 is provided with a positioning pin 21, an iron washer 22, a mounting screw hole 23 and a positioning boss 25, and the knob attraction plate 2 is further provided with four recesses 24.

In the present invention, the lock case 3 is provided with a knob matching counterbore 31, an attraction plate mounting hole 32, a rotary rod mounting hole 33, a gear mounting base 34, an attraction plate positioning column limiting slot 35, a motor mounting detent 36, a motor plate fixing hole 37, a door sensor bar limiting slot 38, and a door sensor bar and plate fixing hole 39.

In the present invention, a plurality of transmission teeth 42 are evenly distributed on a periphery of the transmission gear 4, photoelectric baffles 41 are arranged inside the gear bore of the transmission gear 4, and the transmission gear 4 is further provided with a step bore 43 matching the rotary rod.

In the present invention, an outer wall of the rotary rod 5 is provided with a photoelectric baffle 51, an upper end of the rotary rod 5 is provided with an outer circle 52 matching a lock case hole 33, an outer peripheral surface of the rotary rod 5 is provided with a surface 53 matching the transmission gear, an inner cavity of the rotary rod 5 is provided with a square hole 54 matching a joint pin, and the inner cavity of the rotary rod 5 is further provided with a counterbore 55 matching a protrusion of the attraction plate.

In the present invention, an outer peripheral surface of the connecting sleeve 6 is provided with a square shaft surface 62 matching the rotary rod, and an inner cavity of the connecting sleeve 6 is provided with a square hole 61 matching the plug follower.

In the present invention, the circuit board 7 is provided with a rotary rod hole 71, a photoelectric switch 72 (K3) for determining a gear state, and a photoelectric switch 73 (K2) a photoelectric switch 74 (K1) for determining a rotation state of the rotary rod.

In the present invention, the rear mounting plate 10 is provided with a hole 101 matching the connecting sleeve 6.

In the present invention, the motor module 8 is provided with an output gear 81 and a motor module positioning boss 82, and the motor module fixing plate 9 is provided with a motor positioning slot 91 and a mounting screw through hole 92.

In the present invention, the plug follower 11 is provided with a follower 111 which matches a lock transmission hole, the door sensor bar 12 is provided with a door sensor PCB board 122, the door sensor PCB board 122 is provided with a magnetic sensor chip 121 and door sensor signal wiring 123, and at least one screw through hole 131 is formed in the door sensor bar fixing plate 13.

In the present invention, the deadbolt body 15 is provided with a transmission wheel 151 which matches the plug follower 111, and the door sensor strong magnet 14 is provided with a 3M high strength adhesive or tape 141 thereon so as to be fixed to a door.

The plug follower 11 is installed in a front lock body, the follower 111 matches the wheel 151 of the deadbolt body 15 and inserted into the hole 61 of the connecting sleeve 6, and the square shaft surface 62 of the connecting sleeve 6 matches the hole 54 of the rotary rod 5. An outer circle surface 52 of the rotary rod 5 matches the lock case hole 33, a flange 53 matches the holes 43 of the transmission gear, and the counterbore 55 is fastened to the boss 25 of the knob attraction plate 2 with screws (if the knob needs to be fixed, the knob base can be connected and fastened to a hot-melt nut in the knob with a long screw). After the transmission gear 4 and the motor module 8 are screwed onto the surface 34 of the lock case and in the mounting detent 36, the gear 81 of the motor module engages with the teeth 42 of the transmission gear 4, so as to drive the rotary rod to rotate and thus drive the knob to rotate. Meanwhile, the follower 111 is driven to rotate to drive the wheel 151 to rotate to realize the extension and retraction of a lock bolt.

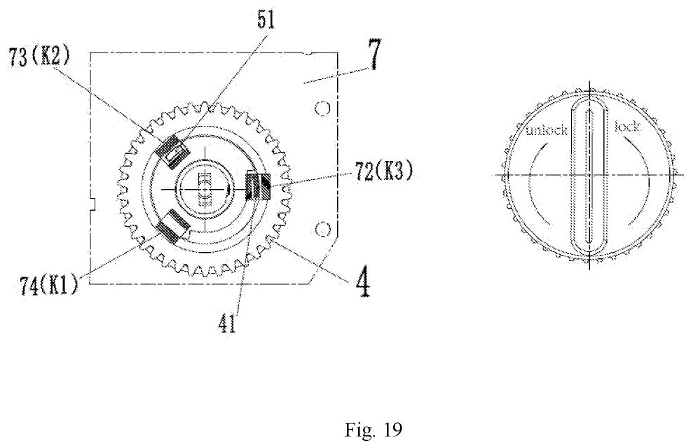

As shown in FIG. 19, when the knob is manually rotated clockwise inside the door, the photoelectric baffle 51 of the rotary rod rotates counterclockwise from K2 to K1, in which case the follower 111 drives the wheel of the lock body to rotate to allow the lock bolt to protrude, thus completing the locking action. When the main control circuit board obtains a manual unlocking signal, the knob is manually rotated counterclockwise, so that the photoelectric baffle 51 of the rotary rod rotates counterclockwise from K1 to K2, in which case the follower 111 drives the wheel of the lock body to rotate to retract the lock bolt, thus completing the unlocking action.

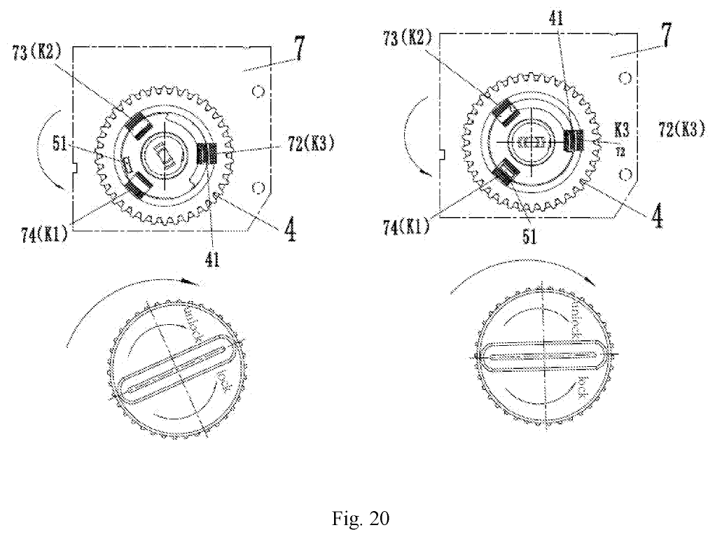

As shown in FIG. 20, when the door is closed, the chip 121 on the door sensor bar detects that the door has been closed through the strong magnet on an edge of the door, the door sensor 12 sends a signal to the mainboard 7, which controls the motor to rotate. When the mainboard detects that the photoelectric baffle 51 of the rotary rod stops at K2 at this moment, the transmission gear rotates 90 degrees clockwise, and the photoelectric baffle 41 of the transmission, gear leaves K3. The transmission gear drives the rotary rod to rotate clockwise, and the photoelectric baffle 51 leaves K2 and enters K1. When the mainboard detects that the baffle 51 stops at K1, the motor drives the transmission gear to rotate 90 degrees counterclockwise, and the photoelectric baffle 41 of the transmission gear enters and stops at K3. In this way, the automatic locking action is completed.

When a correct password or fingerprint is input, the mainboard controls the motor to rotate. When the mainboard detects that the photoelectric baffle 51 of the rotary rod stops at K1, the motor drives a main gear to rotate 90 degrees counterclockwise, and the photoelectric baffle 41 of the main gear leaves K3, which drives the photoelectric baffle 51 of a rotating shaft of the rotary rod to leave K1 to enter K2 and generate a signal when it stops. The transmission gear of the motor rotates 90 degrees counterclockwise, and the photoelectric baffle 41 of the transmission gear enters and stops at K3. In this way, the automatic unlocking action is completed.

When someone outside the door tries to unlock the door with a key, the key rotates to drive the follower to rotate, the follower drives the rotary rod to rotate, and the photoelectric baffle on the rotary rod switches between K1 and K2, giving signals for locking or unlocking the door, which is similar to the locking and unlocking, actions inside the door by manually operating the knob.

In this way, locking and unlocking can be realized through a fingerprint, password or key from the outside, and by manually operating the knob or pressing a button from the inside. In addition, with signals sent by the door sensor chip, automatic locking can be realized, which greatly facilitates user operation and improves security.

To sum up, the intelligent lock device is novel in structural design; with the door sensor function featuring strong magnetic induction, the intelligent lock device can realize automatic locking; meanwhile, the knob can be separated from and integrated with a rear lock body through the strong magnet; and due to the adoption of photoelectric control, the lock parts are simple in structure and easy to manufacture, and the processing and manufacturing of the circuit board are also easy and stable.

It should be noted that in this context, the terms such as “comprise,” “include” or any variation thereof are intended to cover a non-exclusive inclusion, such that a process, method, article, or apparatus that includes a series of elements not only includes those listed elements but also includes other elements not expressly listed or also includes inherent elements of such a process, method, article, or apparatus. An element preceded by “comprises/includes a/an” does not, without more constraints, preclude the existence of additional identical elements in the process, method, article, or apparatus that comprises/includes the element.

It is obvious to those skilled in the art that the present invention is not limited to the details of the above-mentioned exemplary embodiments, and can be implemented in other specific for ns without departing from the spirit or essence of the present invention. Therefore, the embodiments should be regarded as exemplary and non-limiting in every respect. The scope of the present invention is defined by the appended claims rather than the above description. Therefore, it is intended, to include all changes that fall within the meaning and scope of the equivalent elements of the claims within the scope of the present invention. Any reference numerals used in the claims are not to be construed as limiting the scope of the claims.

1. An intelligent lock device with a photoelectric switch-controlled motor, comprising: a lock case (3) and a rear mounting plate (10), a knob attraction plate (2) being mounted to an end face of the lock case (3), a knob (1) being mounted to the knob attraction plate (2), the rear mounting plate (10) being attached to the lock case (3) using a snap-fit connection, a transmission gear (4) being installed at an inner side of the lock case (3), the transmission gear (4) meshing with a motor module (8), the motor module (8) being fixed to a motor fixing plate (9), a gear bore being formed in a center of the transmission gear (4), a rotary rod (5) penetrating through the gear bore, the rotary rod (5) being drive-connected to the knob (1), the rotary rod (5) being connected to a connecting sleeve (6), the connecting sleeve (6) penetrating through a circuit board (7) to be connected to a deadbolt body (15), and the deadbolt body (15) matching a plug follower (11), and further comprising: a door sensor bar (12) and a door sensor plate (13), the door sensor bar (12) being mounted to the door sensor plate (13), and a sensor magnet (14) mounted at one side of the door sensor plate (13).

2. The intelligent lock device with a photoelectric switch-controlled motor of claim 1, wherein the circuit board (7) is provided with a rotary rod hole (71), a photoelectric switch (72) K3 for determining a gear state, and a photoelectric switch (73) K2 and a photoelectric switch (74) K1 for determining a rotation state of the rotary rod.

3. The intelligent lock device with a photoelectric switch-controlled motor of claim 1, wherein the motor module (8) is provided with an output gear (81) and a motor module positioning boss (82), and the motor module fixing plate (9) is provided with a motor positioning slot (91) and at least one mounting screw through hole (92).

4. The intelligent lock device with a photoelectric switch-controlled motor of claim 1, wherein the lock case (3) is provided with a knob matching counterbore (31), an attraction plate mounting hole (32), a rotary rod mounting hole (33), a gear mounting base (34), an attraction plate positioning column limiting slot (35), a motor mounting detent (36), a motor plate fixing hole (37), a door sensor bar limiting slot (38), and a door sensor bar and plate fixing hole (39).

5. The intelligent lock device with a photoelectric switch-controlled motor of claim 1, wherein a plurality of transmission teeth (42) are evenly distributed on a periphery of the transmission gear (4), photoelectric baffles (41) are arranged inside the gear bore of the transmission gear (4), and the transmission gear (4) is further provided with a step bore (43) matching the rotary rod.

6. The intelligent lock device with a photoelectric switch-controlled motor of claim 1, wherein an outer wall of the rotary rod (5) is provided with a photoelectric baffle (51), an upper end of the rotary rod (5) is provided with an outer circle (52) matching a lock case hole (33), an outer peripheral surface of the rotary rod (5) is provided with a surface (53) matching the transmission gear, an inner cavity of the rotary rod (5) is provided with a square hole (54) matching a joint pin, and the inner cavity of the rotary rod (5) is further provided with a counterbore (55) matching a protrusion of the attraction plate.

7. The intelligent lock device with a photoelectric switch-controlled motor of claim 1, wherein an outer peripheral surface of the connecting sleeve (6) is provided with a square shaft surface (62) matching the rotary rod, and an inner cavity of the connecting sleeve (6) is provided with a square hole (61) matching the plug follower.

8. The intelligent lock device with a photoelectric switch-controlled motor of claim 1, wherein the knob (1) is composed of a knob base (la), a strong magnet (1b) and a knob case (1c) by hot melting and is detachable from the lock case, and the knob base (la) is provided with four projections A matching recesses of the knob attraction plate (2) and is tightly attracted thereto.

9. The intelligent lock device with a photoelectric switch-controlled motor of claim 1, wherein the rear mounting plate (10) is provided with a hole (101) matching the connecting sleeve (6).

10. The intelligent lock device with a photoelectric switch-controlled motor of claim 1, wherein the knob attraction plate (2) is provided with a positioning pin (21), an iron washer (22), a mounting screw hole (23) and a positioning boss (25), and the knob attraction plate (2) is further provided with four recesses (24).
